(19) United States
(12) Patent Application Publication
(10) Pub. No.: US 2006/0151536 A1
(43) Pub. Date: Jul. 13, 2006

(54) Dispensing device

(75) Inventors: Kon Euan Wong, Glen Waverley (AU); Mark Simon Bayly, Eltham North (AU); Gareth William Jack Lewis, Balwyn (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Acrux DDSpty ltd, West Melbourne (AU)

(21) Appl. No.: 10/539,430

(22) PCT Filed: Dec. 22, 2003
(86) PCT No.: PCT/AU03/01715

§ 371 Date: Jan. 6, 2006

(30) Foreign Application Priority Data
Dec. 20, 2002 (AU) 2002953482

(51) Int. Cl. B67D 5/06

(52) U.S. Cl. 222/183

(57) ABSTRACT

A substance dispensing device is disclosed having a body that defines a chamber for receiving a substance capsule. The capsule is operable to dispense substance therefrom and has an outlet through which substance is dispensed. The body has two relatively movable parts that are moved relatively apart from a rest position to condition the device for use. A closure member associated with the movable part obstructs the outlet when the movable parts are in the rest position.

### FIELD OF THE INVENTION

The present invention relates to a device for dispensing a substance, such as a pharmaceutical, medicinal, or therapeutic substance. The device is particularly, but not exclusively, suited for dispensing a substance in the form of a spray or mist. The invention will be hereinafter described with particular reference to transdermal and/or percutaneous delivery of substances, but it is to be understood that the invention has broader application.

### BACKGROUND OF THE INVENTION

It is usually the case that devices of the foregoing kind can be used on several occasions before the quantity of the substance stored in the device is exhausted. It is also a common requirement that an accurately metered amount of the substance is dispensed each time the device is operated.

Substance dispensing devices of the foregoing kind tend to suffer an unacceptable loss of the substance in the period between uses of the device. That loss is particularly evident in circumstances involving use of a volatile substance. Unintentional loss of the substance is wasteful, and can also interfere with the ability of the device to dispense an accurately metered quantity each time the device is operated. In that regard, accurate metering can be very important in some circumstances.

It is also desirable to guard against possible contamination of the substance by dust and/or other foreign material collecting at or adjacent the substance outlet of the device. That problem is sometimes attended to by providing the device with a removable dust cap which must be replaced after each use of the device. A disadvantage of that solution is that users can overlook the need to replace the cap, and may deliberately refrain from replacing the cap because of the inconvenience involved.

Still another difficulty encountered with conventional devices is the lack of protection against inadvertent or unintentional operation of the device. In the absence of such protection it may be possible for a child to operate the device, and in some circumstances that could have severe adverse consequences.

Yet another problem arises because many devices of the foregoing kind are bulky and/or uncomfortable to use. Bulky devices are difficult to carry, and may be left behind for that reason. Devices that are uncomfortable to use may be neglected because of that fact. In either case—ie., bulky or difficult to use—there is a risk of the user not using the device according to a prescribed program, and as a consequence not obtaining the full benefit of the substance contained in the device.

It is an object of the present invention to provide a substance dispensing device having means for preventing, or minimising, unintentional loss of the substance. It is a further object of the invention to provide a substance dispensing device having convenient and effective means for preventing, or minimising, collection of dust or other foreign material at or adjacent the substance outlet of the device. Still another object of the invention is to provide a substance dispensing device having means for preventing, or minimising, inadvertent or unintentional operation of the device. Yet another object of the invention is to provide a substance dispensing device that is of relatively compact and convenient to use form.

### SUMMARY OF THE INVENTION

According to the present invention, there is provided a substance dispensing device including a body defining a chamber for receiving a substance capsule, the capsule being operable to dispense substance therefrom and having an outlet through which the substance is dispensed, the body having two relatively movable parts that are moved relatively apart from a rest position to condition the device for use, a closure member associated with one of the movable parts wherein the closure member obstructs the opening when the movable parts are in the rest position.

Preferably the movable parts when moved to an in-use position function as a reference means for selecting an appropriate distance between the outlet and a substance target area. Preferably the movable parts when in the in-use position function as a partial shroud that confines the spread of substance exiting the outlet. It is further preferred that the closure member is formed with said one movable member to move therewith.

It is preferred that the device includes an actuator button cooperable with the substance capsule for dispensing substance therefrom, and a stop means that when enabled renders the actuator button inoperable. Preferably the closure member also functions as the stop means so that the stop means is enabled when the closure member is in the rest position interacting with the actuator button to render the actuator button inoperable. Preferably the actuator button is operated by depression thereof along an axis, said one movable member being rotatable about the axis to switch the stop means between the enabled and a disabled condition so that when the stop means is in the enabled condition the actuator button cannot be depressed. It is further preferred that the device include locking means formed with the movable parts to prevent movement of the movable parts from the rest position. Preferably the locking means includes a detent formed with another of the two movable parts which is locatable in an opening formed in said one of the movable parts when said movable parts are in the rest position, whereby the detent must be substantially displaced from the opening to allow the movable parts to be moved from the rest position. Preferably the detent is biased towards being located in the opening. Preferably the opening is a blind cavity having a membrane located at one end of the cavity whereby in use the user depresses the membrane to displace the detent. It is preferred that the movable parts form a cover member covering the outlet when in the rest position. It is preferred that the device include a substance capsule located within the chamber, the substance capsule including pump for dispersing the substance through the outlet. It is also preferred that the device include a viewing window being provided in a side of either of the movable parts for exposing the quantity of substance left in the capsule.

### BRIEF DESCRIPTION OF THE DRAWINGS

It will be convenient to hereinafter describe the invention in greater detail by reference to the accompanying drawings showing a dispensing device to which the invention can be applied. The particularity of those drawings and the related description is not to be understood as superseding the generality of the definition of the invention according to the claims. The drawings show an example embodiments of aspects of the invention.

FIG. 1 is a side, perspective, isometric view of a preferred embodiment of a dispensing device of the present invention with movable parts of a body in a rest position;

FIG. 2 is a front, elevational view of the device shown in FIG. 1;

FIG. 3 is a side, elevational, cross sectional view of the dispensing device shown in FIG. 1;

FIG. 3a is an enlarged, partial, elevational view of an alternate detent arrangement for use in the dispensing device of the present invention to that shown in FIG. 3;

FIG. 4 is a side, perspective view of the dispensing device of the present invention with the movable parts in an in use position;

FIG. 5 is a side, elevational, exploded view of the dispensing device of the present invention with the movable parts in isolation; and

FIG. 6 is a side, elevational, exploded view of another embodiment of the dispensing device of the present invention with one of the movable parts and a button.

### DETAILED DESCRIPTION

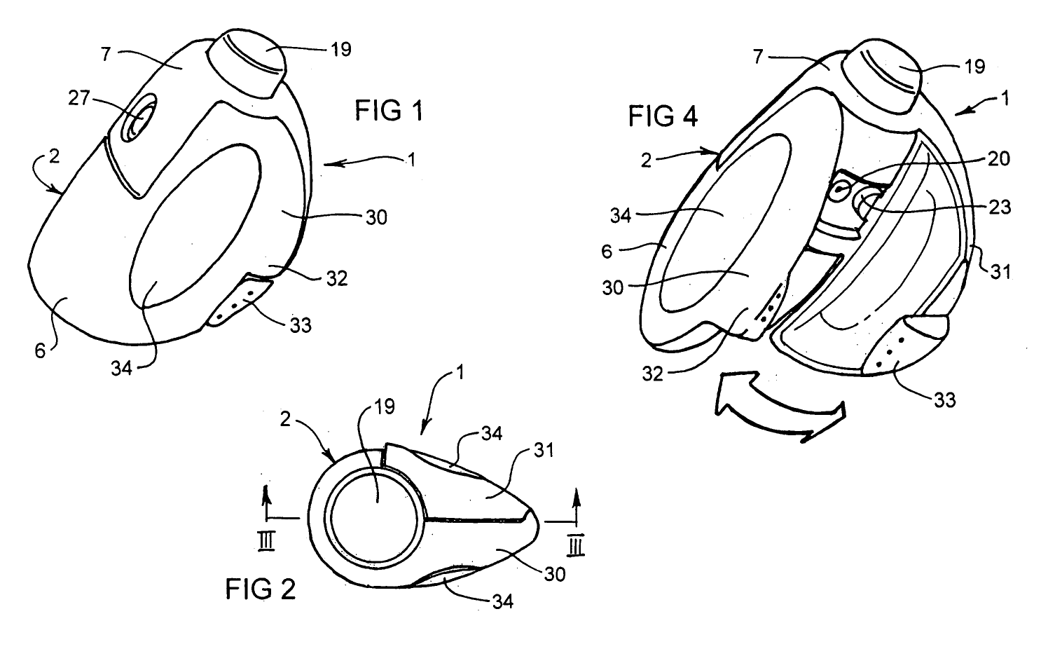

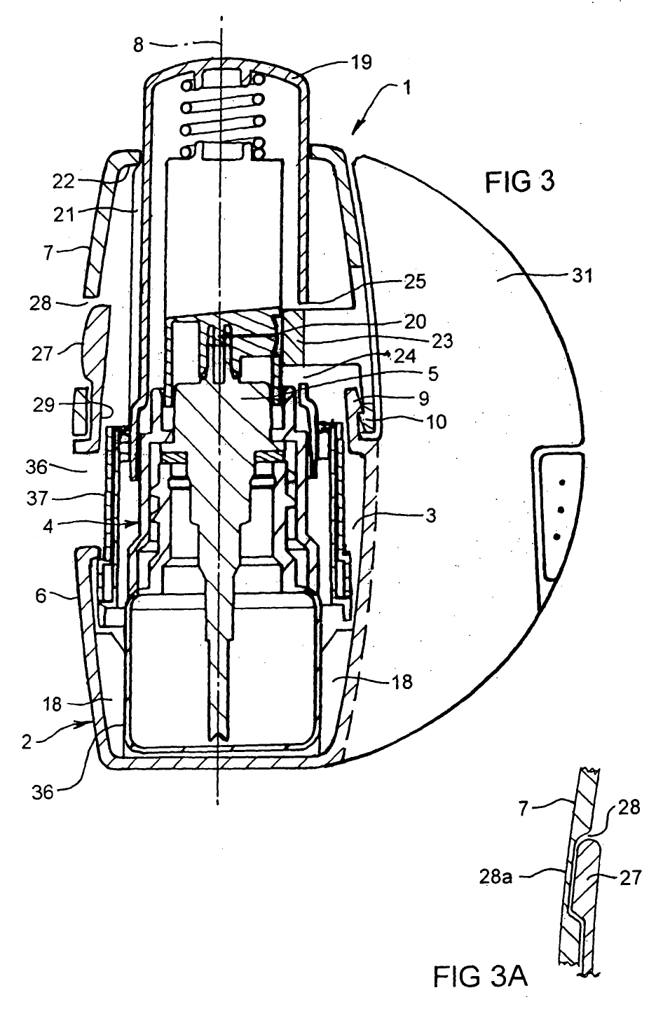

FIGS. 1 to 4 show an example device 1 to which an embodiment of each aspect of the invention has been applied. The device 1 includes a hollow body 2 that defines a chamber 3 (FIG. 3) for receiving a substance capsule 4. The contents (the substance) of the capsule 4 will be selected to suit the intended use of the device 1. In the example shown, the capsule 4 includes a manually operable pump 5 for dispensing a metered quantity of the substance. Other arrangements could be adopted, such as an aerosol-type dispenser.

In the arrangement shown, the body 2 includes two parts 6 and 7 that are movable relative to one another about the central axis 8 (FIG. 3) of the chamber 3 for a reason hereinafter explained. The body parts 6 and 7 may be connected together in any appropriate manner. By way of example, the two parts 6 and 7 may snap engage with one another. If desired, the connection between the two parts 6 and 7 may be releasable to enable removal and possible replacement of the capsule 4. In some circumstances however, such replacement may not be permitted because of health regulations.

FIG. 5 is an exploded view of the two body parts 6 and 7 showing one form of connecting means enabling snap connection of those parts. In the example shown, the connecting means includes at least one detent rib 9 provided on the outside of the body part 6, and a cooperable ledge 10 provided on the inside of the body part 7. It is preferred to provide two ribs 9 arranged in diametrically opposed relationship on the body part 6, and to provide two ledges 10 at appropriate positions on the body part 7. As shown, the detent ribs 9 may be provided on a cylindrical neck portion 11 of the body part that is of reduced diameter so as to fit within the lower open end 12 of the body part 7. Each detent rib 9 has a sloping upper surface 13 to facilitate movement across the respective cooperative ledge 10, and an abrupt lower surface 14 that locates over the ledge 10 so as to resist separation of the two parts 6 and 7. The lower edge 15 of the body part 7 may slidably engage a shoulder 16 of the body part 6 when the two parts 6 and 7 are connected together.

It is preferred to provide means for limiting the degree to which the two parts 6 and 7 can rotate relative to one another about the axis 8. In the particular arrangement shown by FIG. 5, that limiting means includes a stop 17 located at each end of each of the ledges 10. The distance between the stops 17 of a ledge 10 is related to the length of the rib 9 engaging that ledge 10 so that the body parts 6 and 7 are capable of an appropriate degree of relative movement.

The body part 6 may be provided with capsule retaining means that is operative to prevent or resist relative rotation of the capsule 4 about the axis 8. As shown, the capsule retaining means may include a plurality of ribs 18 provided on the inside surface of the chamber 3 and arranged to grip the capsule 4 to an extent sufficient to resist relative rotation of the capsule 4.

Also in the arrangement shown, an actuator button 19 is accessible at an upper end of the body 2 and cooperates with the pump 5 in a manner such that depression of the button 19 causes operation of the pump 5. When the pump 5 is operated, the substance is expelled through an outlet nozzle 20 of the pump 5, possibly in the form of a spray. The pump 5 operates in a known manner to pressurize the contents of the capsule 4 and thereby force a metered quantity of the substance to be expelled through the nozzle 20. At least one longitudinally extending rib 21 may be provided on the button 19 so as to resist separation of the button 19 from body 2. As shown by FIG. 3, the upper end of the rib 21 is engageable with an opposed surface 22 of the body part 7. Other forms of button retaining means could be used.

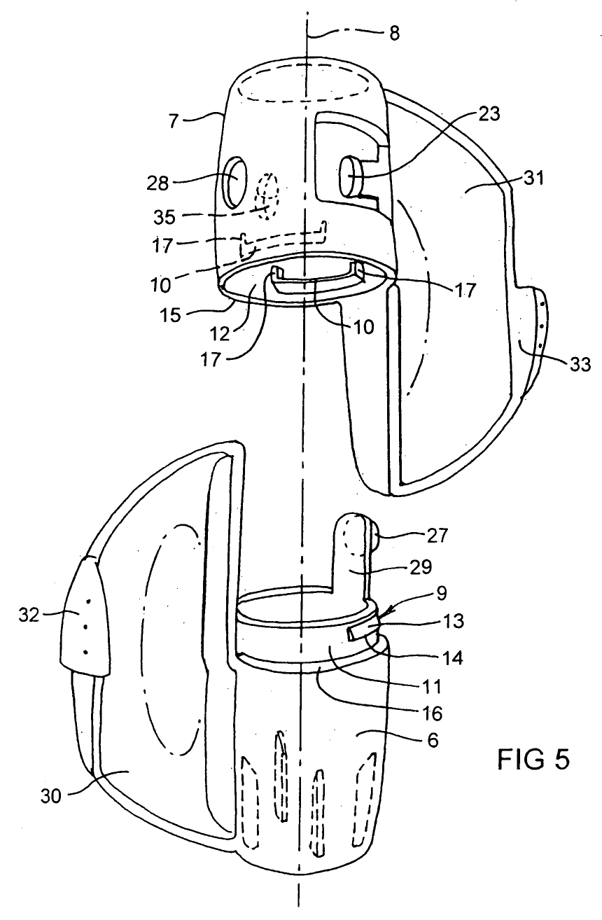

The body parts 6 and 7 are relatively movable between a rest position as shown by FIGS. 1 and 2, and a use position as shown by FIG. 4. When the parts 6 and 7 are in the rest position, it is preferred that stop means (as hereinafter described) is operative to prevent depression of the button 19 and thereby prevent operation of the pump 5. Also in that position, the parts 6 and 7 may cooperate to form a cover over the nozzle 20 and thereby inhibit collection of dust or other foreign material at or adjacent the nozzle 20. When the parts 6 and 7 are in the use position, the stop means is preferably deactivated, thereby allowing the button 19 to be depressed. Also in that position, the parts 6 and 7 are separated so as to expose the nozzle 20 and thereby provide a clear space through which the substance expelled through the nozzle 20 can move towards a target area.

It is a feature of a preferred embodiment of the invention that nozzle closing means is associated with one of the body parts 6 and 7 so as to be operative to close the nozzle 20 when the parts 6 and 7 are in the rest position. Closure of the nozzle 20 when the device 1 is not in use has the benefit of preventing or minimising unintentional loss of the substance. In the example shown, the nozzle closing means is formed by a member 23 attached to or formed integral with the body part 7. As shown by FIG. 3, when the parts 6 and 7 are in the rest position, a terminal end of the member 23 bears against a surface surrounding the nozzle 20 and thereby closes the nozzle 20. The member 23 is moved clear of the nozzle 20 when the parts 6 and 7 are moved to the use position (FIG. 4).

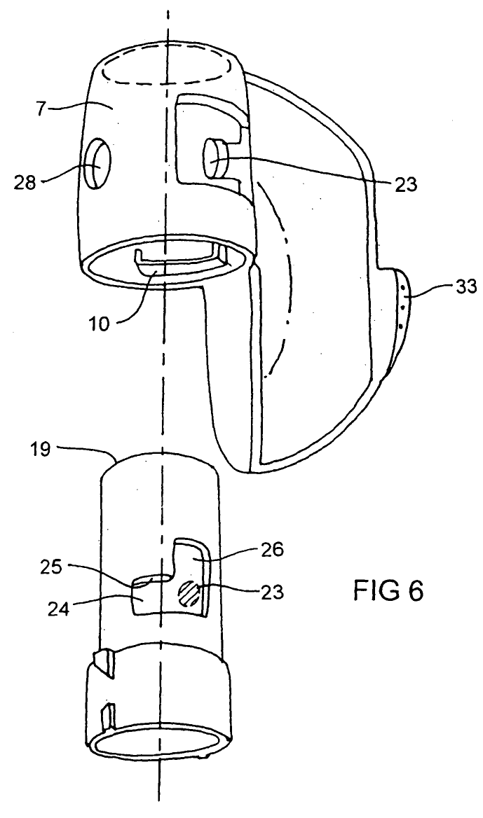

The member 23 may also function as the stop means preventing operation of the actuator button 19 when the body parts 6 and 7 are in the rest position. For that purpose, the member 23 may project through an opening 24 in one side of the button 19. As will be apparent from FIG. 3, when the parts 6 and 7 are in the rest position, the button 19 cannot be depressed to operate the pump 5 because of engagement between the member 23 and the upper edge 25 of the button opening 24. The button stop means is preferably disabled as a consequence of moving the body parts 6 and 7 into the use position as shown by FIG. 4. That may be achieved in any appropriate manner. One satisfactory arrangement is shown by FIG. 6, which is an exploded view of the actuator button 19 and the body part 7. In that particular arrangement, the member 23 is moved clear of the edge 25 when the body parts 6 and 7 are in the use position, and is aligned with an upward extension 26 of the opening 24. Downward movement of the button 19 is permitted as a consequence of the member 23 being receivable in the extension 26.

Releasable locking means may be provided to prevent the body parts 6 and 7 moving out of the rest position. In the particular arrangement shown, that locking means includes a detent 27 attached to or formed integral with the part 6, and an opening 28 formed in the part 7 and arranged to receive the detent 27 as shown by FIGS. 1 and 3. Other forms of locking means could be employed.

The locking means may be released in any suitable fashion. In the particular arrangement shown, the detent 27 is exposed at the outside of the body 2 and is therefore able to be employed as part of the release means. For that purpose, the detent 27 is provided at an end portion of a flexible arm 29 (FIG. 3) attached to or formed integral with the body part 6. The arrangement is such that the detent 27 can be manually engaged and pressed into the chamber 3 so as to clear the opening 28 and thereby permit the parts 6 and 7 to be rotated about the axis 8 relative to one another.

In an alternative arrangement (not shown), a thin and flexible membrane may be attached to the part 7 so as to extend across the opening 28 and overly the outer surface of the detent 27. The membrane thereby prevents direct contact with the detent 27, and may be opaque so as to hide the existence of the detent 27. In the latter case the membrane, or the body part 7, may be marked to indicate the need to press against the membrane in order to release the detent 27. In operation, the membrane is pressed so as to be deflected inwards to engage against the detent 27. Continued pressure against the membrane causes further deflection and results in release of the detent 27 as described above. One advantage of that arrangement is that it minimises the possibility of unintentional, or improper, use of the device 1. By way of example, the presence of the membrane can reduce the possibility of the device 1 being operated by a child.

Although the membrane is described above as being a separately formed member, it could be an integral part of the body part 7 as shown diagrammatically by FIG. 3A. That is, the detent 27 may be received in an internal blind cavity 28, the base 28a of which is sufficiently flexible to function in the manner of the membrane described above.

The arm 29 preferably has sufficient resilience to move the detent 27 outwards when manually applied pressure is removed from the detent 27. As a result, the detent 27 is automatically returned to engagement within the opening 28 when the parts 6 and 7 are moved back into the rest position.

Effective operation of the release means by a child is made difficult by the fact that manual pressure must be retained on the detent 27 while the parts 6 and 7 are being moved out of the rest position. Premature release of pressure on the detent 27 will result in the detent 27 moving back into the opening 28 thereby preventing the parts 6 and 7 being moved to an extent sufficient to free the button 19 from the restraint of the stop means 23.

It is preferred that an outwardly extending wing section 30 is connected to or formed integral with the body part 6, and that a similar wing section 31 is connected to or formed integral with the body part 7. The wing sections 30 and 31 may cooperate to form cover means such as to prevent or minimise the collection of dust, or other foreign material, at or adjacent the nozzle 20. The wing sections 30 and 31 may include finger engageable portions 32 and 33 through which the user may apply pressure to cause separation of the wing section 30 and 31, and thereby cause movement of the body parts 6 and 7 from the rest position to the use position.

When the wing sections 30 and 31 are separated to the full extent possible, they preferably form a partial shroud that confines the lateral spread of the substance expelled through the nozzle 20. At that separated condition, the wing sections 30 and 31 may also provide a reference for establishing a suitable distance between the nozzle 20 and the target area onto which substance expelled through the nozzle 20 is to be deposited.

It is preferred that a shallow cavity or recess 34 is provided in the outside surface of each of the wing sections 30 and 31. The arrangement of the recesses 34 is such that they provide convenient holding locations for the user when the wing sections 30 and 31 are separated as shown by FIG. 4. That is, a user can comfortably grasp the device 1 in one hand by placing the thumb in one recess 34, and by placing one or two fingers in the other recess 34. The index finger can then be used to press the button 19 downwards and thereby operate the pump 5.

Appropriate positioning of the recesses 34 can enable the user to hold the device 1 by a squeeze action without causing the wing sections 30 and 31 to move inwards towards one another. That is, the squeeze action is applied in a line passing through, or close to, the axis 8. In addition, or alternatively, unintentional inward movement of the wing sections 30 and 31 may be resisted by suitable releasable holding means provided on the body parts 6 and 7. In one preferred arrangement, the holding means includes the detent 27 and a blind cavity 35 (FIG. 5) formed in an inner surface of the body part 7. The cavity 35 is positioned to receive the detent 27, or part of that detent, when the body parts 6 and 7 are moved into the use position. The shape and/or depth of the cavity 35 is preferably such that the detent 27 can be forced out of the cavity 35 by moderate closing pressure applied to the wing sections 30 and 31. That is to be contrasted with the more positive locking action produced by location of the detent 27 within the opening 28, and which cannot be comfortably released without pressing the detent 27 inwards as previously described.

If desired, a viewing window 36 (FIG. 3) may be provided in a side of the body part 6 to enable the user to see when the quantity of the substance in the capsule 4 is getting low. In that regard, the remaining quantity of the stored substance may be observable because of the transparent nature of the container 36 (FIG. 3) but forms part of the capsule 4. Alternatively, the remaining quantity may be indicated by a use indicator 37 (FIG. 3) located within the body part 6. One form of such a use indicator as described in our co-pending patent application entitled “Usage Indicator”.

It will be apparent from the foregoing description that a substance dispensing device incorporating the invention has an effective and easy to use closure means for preventing unintentional loss of the substance. The invention also provides for an effective and easy to use cover that prevents or inhibits collection of dust or other foreign material at or adjacent the device outlet. In addition, a device incorporating the invention is not easily operated by a child, and therefore has a desirable factor of safety. Furthermore, the device is of compact form, and is comfortable to use.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A substance dispensing device including a body defining a chamber for receiving a substance-dispensing capsule for dispensing said substance therefrom and having an outlet through which said substance is dispensed, said body having two relatively movable parts that are moved relatively apart from a rest position to a use position in which said device may be operated, and a closure member associated with one of said two relatively movable parts wherein said closure member obstructs said outlet when said two relatively movable parts are in said rest position.

2. A substance dispensing device according to claim 1, wherein said two relatively movable parts when moved to said use position function as a reference means for selecting an appropriate distance between said outlet and a substance target area.

3. A substance dispensing device according to claim 1, wherein said two relatively movable parts when said use position function as at least a partial shroud that confines the spread of said substance exiting said outlet.

4. A substance dispensing device according to claim 2, wherein said two relatively movable parts when in said use position function as at least a partial shroud that confines the spread of said substance exiting said outlet.

5. A substance dispensing device according to claim 1, wherein said closure member is formed with said one of said two movable members to move therewith.

6. A substance dispensing device according to claim 1 including an actuator button cooperable with said substance-dispensing capsule for dispensing said substance therefrom, and stop means that when enabled renders said actuator button inoperable.

7. A substance dispensing device according to claim 6, wherein said closure member also includes said stop means whereby said stop means is enabled when said closure member is in said rest position by interacting with said actuator button to render said actuator button inoperable.

8. A substance dispensing device according to claim 7, wherein said actuator button is operated by depression thereof along an axis, said one of said two relatively movable members being rotatable about said axis to switch said stop means between said enabled and a disabled condition whereby when said stop means is in said enabled condition the said actuator button cannot be depressed.

9. A substance dispensing device according to claim 1 including locking means formed with said two relatively movable parts to prevent movement of said two relatively movable parts from said rest position.

10. A substance dispensing device according to claim 9, wherein said locking means includes a detent formed with the other of said two relatively movable parts which is locatable in an opening formed in said one of said two relatively movable parts when said two relatively movable parts are in said rest position, whereby said detent must be substantially displaced from said opening to allow said two relatively movable parts to be moved from said rest position.

11. A substance dispensing device according to claim 10, wherein said detent is biased towards being located in said opening.

12. A substance dispensing device according to claim 10 wherein said opening comprises a blind cavity, and including a membrane located at one end of said blind cavity whereby in use said membrane can be depressed by a user to displace said detent.

13. A substance dispensing device according to claim 1, wherein said two relatively movable parts form a cover member covering said outlet when said two relatively movable parts are in said rest position.

14. A substance dispensing device according to claim 1, including a substance-dispensing capsule located within said chamber, said substance-dispensing capsule including a pump for dispersing said substance through said outlet.

15. A substance dispensing device according to claim 1 including a viewing window provided in a side of either of said two relatively movable parts for exposing the quantity of said substance left in said substance-dispensing capsule.
